(19) United States
(12) Patent Application Publication
(10) Pub. No.: US 2013/0005412 A1
(43) Pub. Date: Jan. 3, 2013

(54) Electronic instrument attached to a hand

(76) Inventor: Andy McCurdy, Bonita Springs, FL (US)

(21) Appl. No.: 13/135,287

(22) Filed: Jul. 1, 2011

(51) Int. Cl. H04W 92/08

(52) U.S. Cl. 455/575.6

(57) ABSTRACT

The inventive concept is directed to a system for attaching an electronic instrument to the inside of a hand. The system includes a fixed plate removably attached to an electronic instrument. The system further consists of a fixed plate attached to the cell phone and a rotational plate attached to the fixed plate. The rotational plate has threaded there through an elastic ban having loops which each will a middle finger and a ring finger, respectively, designed to hold the hand of a user snugly on the electronic instrument. The fixed plate may also be attached to a case of a cell phone.

### BACKGROUND OF THE INVENTION

Cell phones and various other instruments are in great use in various areas and countries. When the phone is used to answer a call or to send a message, it is hand held and it is difficult to hold the cell phone in certain desirable positions. It is usually held in one hand with the fingers straddling the front of the instrument. Most of the time the thumb of the user does the texting by manipulating the various keys. It often happens that various keys are manipulated by error depending how the cell phone is held. Many times the phone is dropped causing damage.

### Brief Description of the Invention

The inventive concept of the invention involves a system whereby the cell phone is permanently held on the inside of the hand by elastic straps that capture the middle finger and the ring finger. Elastic straps are used because there are many different hand sizes and fingers but no matter of the different hand and finger sizes, the cell phone will stay snug on the hand. In addition it is desirable that the instrument will remain rotational relative to the mounting plate of the straps and thereby relative to the hand that is holding the cell phone. It is also desirable that the cell phone can easily be removed from the location of the mounting for maintenance and service reasons.

### BRIEF DESCRIPTION OF THE DRAWINGS

FIG. 1 illustrates the mounting of a cell phone in a casing;

FIG. 2 shows the mounting system to be attached to a cell phone;

FIG. 3 is a mounting plate that can rotate relative the mounting system;

FIG. 4 illustrates a bottom view of a mounting plate;

FIG. 5 shows a side view of the bottom plate of FIG. 4.

### DETAILED DESCRIPTION OF THE INVENTION

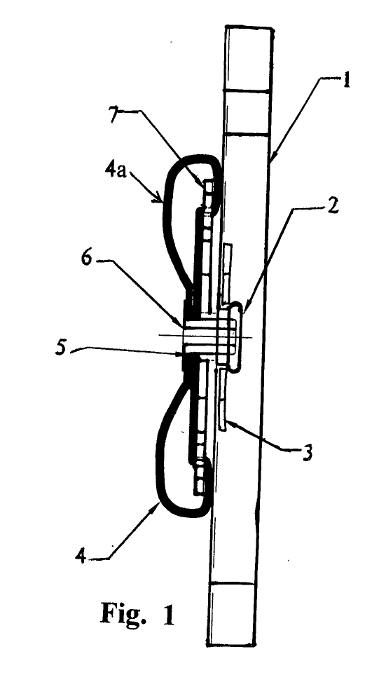

FIG. 1 illustrates the basic system wherein a cell phone case 1 that normally receives the cell phone (not shown). In the middle of the case 1 there is located a socket fastener 2 that will attach the hand attaching system to the inside of a hand (not shown). The hand attaching system includes a fixed plate which is located on the inside or the bottom of the casing 1. On the outside of the casing 1 and on its outside wall there is located a rotating plate 7 which is rotational around the stud fastener 5. The rotational plate has various openings or slots (explained in FIG. 3). The slots receive an elastic band 4 which is threaded into the rotational plate in such a way to create the loops 4 and 4a. The purpose of the loops 4 and 4a is to receive the middle finger and the ring finger so that the phone case 1 including the cell phone fastened therein will be located on the inside of the hand. Once the elastic band is threaded into the rotational plate 7, the loose ends will be fastened to each other in the vicinity and around the stud fastener by way of an adhesive 5. The rotational plate 7 and the elastic band 4 and 4a will finally be held in place by the stud fastener 6 which will be fastened over the socket fastener 2.

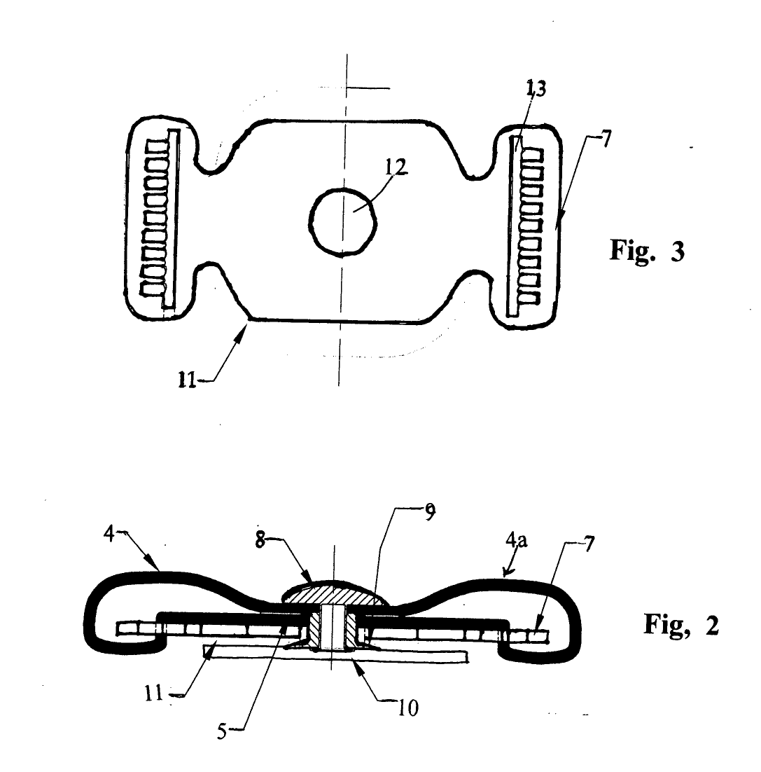

FIG. 2 is side view which is similar to the system explained with reference to FIG. 1 except that this system does not include the cell phone case of FIG. 1. In this example, the rotational plate 7 is mounted to a fixed plate 11 which is fastened to the back wall of the call phone by way of a double sided adhesive tape. At 9 is shown the stud which penetrates through the back of the fixed plate which will receive the locking cap 8 on the other side. The stud will receive the rotational plate 7 which has threaded thereon the elastic band to thereby create the finger receiving loops 4 and 4a. In this FIG. 2 one can easily see the threading arrangement of the continuous elastic band wherein the loose ends are captured under the and captured under the locking cap 8.

FIG. 3 illustrates a top view of the rotational plate 7 having a central opening therein which will receive the stud 9. Also on the bottom of the rotational plate one can see the fixed plate 11 which is mounted to the back wall of the cell phone by way of a double adhesive tape as was explained in FIG. 2. The rotational plate has lateral slots 7 therein which serve the purpose of threading the elastic band there through.

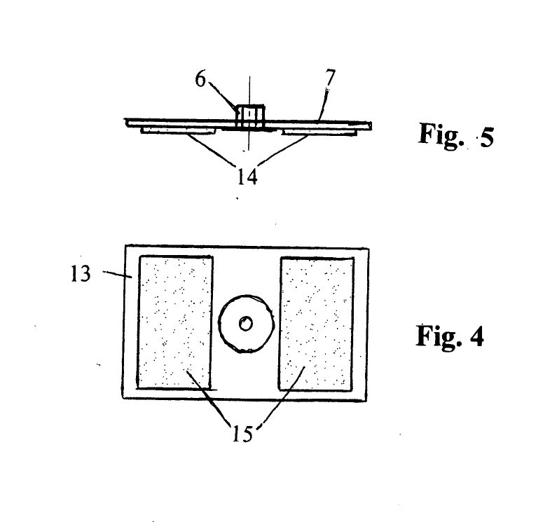

FIG. 4 shows the bottom of the fixed plate 13 and a different way of fastening the same to the back wall of the cell phone or any other electronic instrument. The bottom of the fixed plate 13 has attached thereon one part of a VELCRO fastener in this case the female part, or the loop part

In FIG. 5 there is shown a side view of the fixed plate 13 having the other part of the VELCRO fastener attached thereto, in this case the male part, or the hook part. At 6 is shown the fastening stud 6 which captures the rotating plate and the elastic band threaded there through.

What I claim is:

1. A system for attaching an electronic instrument to a hand of a user, said system includes a fixed plate, means for attaching a rotational plate on one side thereof to said fixed plate, means for attaching said fixed plate on one side thereof to a back wall of a cell phone, means for attaching said rotational plate on another side thereof to a middle finger and a ring finger to said hand so that said cell phone is attached to an inside of said hand.

2. The system of claim 1, wherein said fixed plate is attached to an inside of a cell phone case.

3. The system of claim 1, wherein said means for attaching said rotational plate to said fingers is an elastic band threaded into said rotational plate in such a manner to create loops for said middle and said ring finger.

4. The system of claim 1, wherein said for attaching said fixed plate to a back wall of said electronic instrument is a double sided adhesive.

5. The system of claim 1, wherein said means for attaching said fixed plate to a back wall of said electronic instrument is a hook and loop system.

6. The system of claim 1, wherein said means for attaching said rotational plate to said fixed plate is a stud fastened to said fixed plate.

7. The system of claim 3, wherein said elastic band is threaded through lateral slots located at ends of said rotational plate.
